(19) United States
(12) Patent Application Publication
(10) Pub. No.: US 2013/0212850 A1
(43) Pub. Date: Aug. 22, 2013

(54) ASSEMBLY APPARATUS FOR BEARING ASSEMBLY

(71) Applicants: Hong Fu Jin Precision Industry (ShenZhen) Co., Ltd., (US); Hon Hai Precision Industry Co., Ltd., (US)

(72) Inventors: JUN LIU, Shenzhen (CN); CHUN-MING ZHANG, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 13/749,680

(22) Filed: Jan. 25, 2013

(30) Foreign Application Priority Data
Feb. 17, 2012 (CN) 201210035870.3

(51) Int. Cl. F16C 43/02

(52) U.S. Cl. CPC F16C 43/02
USPC 29/244

(57) ABSTRACT

An assembly apparatus for automatically assembling a bearing assembly includes a base, a transferring mechanism, a first assembly mechanism, and a second assembly mechanism. The transferring mechanism is movably mounted on the base, for transferring and positioning the bearing seat. The first assembly mechanism is mounted on the base adjacent to the transferring mechanism, for installing the bearing and the bushing into the mounting hole of the base. The second assembly mechanism is mounted on the base adjacent to the first assembly mechanism, for installing the latching ring into the latching groove of the bearing seat.

### BACKGROUND

1. Technical Field

The present disclosure relates to assembly apparatuses, and particularly to an assembly apparatus for bearing assembly.

2. Description of Related Art

A bearing assembly generally includes a bearing seat, a bearing, a bushing, and a latching ring. During an assembly process, the bearing and the bushing are manually positioned on a same straight line, and then the bushing is inserted into the bearing by an external mechanical force; the bearing installed with the bushing is manually mounted in a mounting hole of the bearing seat; and lastly, the latching ring is manually sleeved on the bearing, for latching the bearing in the bearing seat. Such an assembly process is complicated, and has a low efficiency. In addition, the bearing contacts with the hands of the operator, so that the bearing may rust easily.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure.

Moreover, in the drawings, like reference numerals designate corresponding parts throughout the several views.

FIG. 1 is an assembled, isometric view of an embodiment of an assembly apparatus.

FIG. 2 is an exploded, isometric view of a bearing assembly to be assembled by the assembly apparatus of FIG. 1.

FIG. 3 is an exploded, isometric view of the assembly apparatus of FIG. 1.

FIGS. 4 through 6 are partial assembled, isometric views of the assembly apparatus of FIG. 1.

FIG. 7 is a sectional view of the assembly apparatus of FIG. 1, taken along line VII-VII of FIG. 1.

FIG. 8 is another sectional view of the assembly apparatus of FIG. 1, taken along line VIII-VIII of FIG. 1.

FIG. 9 is another sectional view of the assembly apparatus of FIG. 1, taken along line IX-IX of FIG. 1.

### DETAILED DESCRIPTION

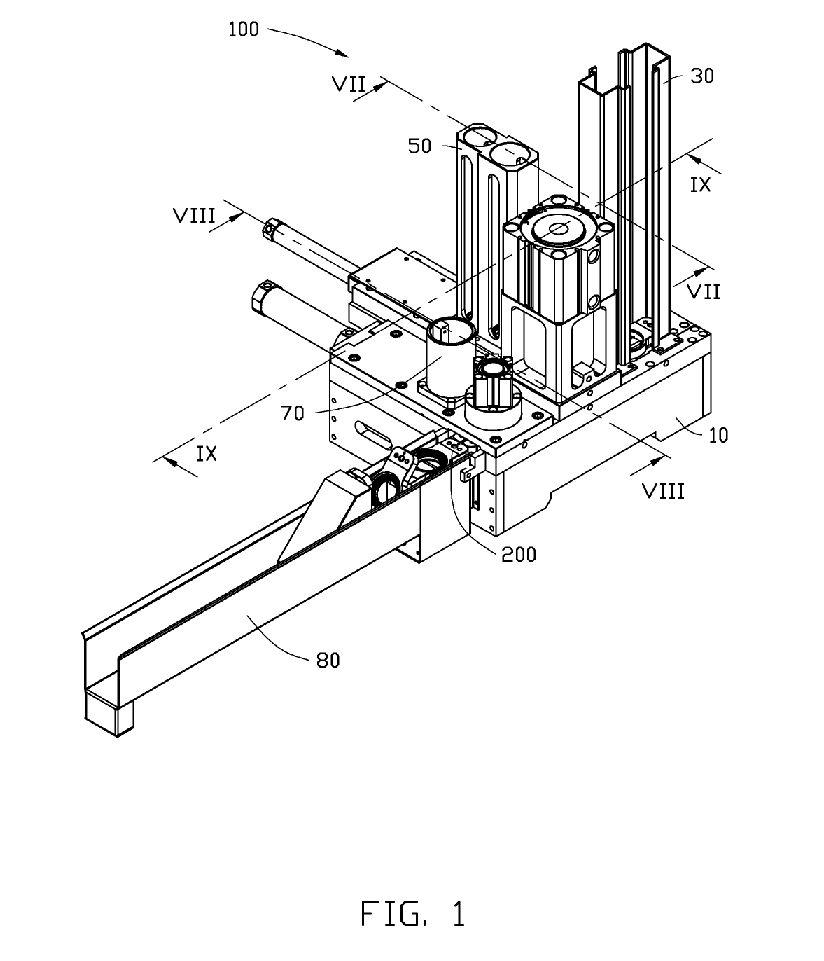

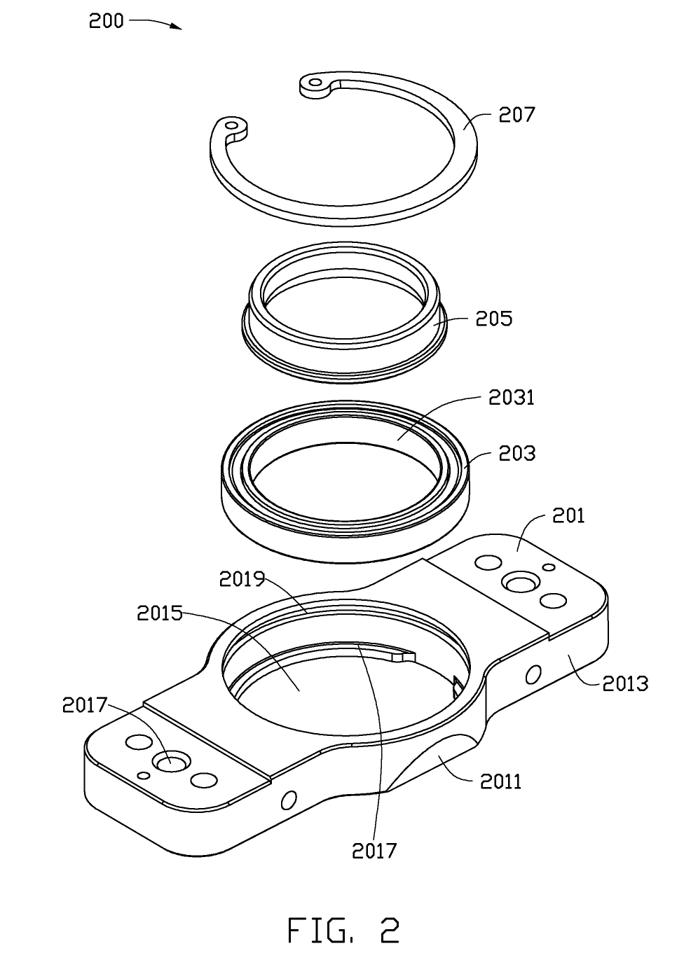

FIG. 1 shows an embodiment of an assembly apparatus 100 used for assembling a bearing assembly 200 (shown in FIG. 2). The bearing assembly 200 includes a bearing seat 201, a bearing 203, a bushing 205, and a latching ring 207. The bearing seat 201 includes a base portion 2011 and a guiding portion 2013 extending from opposite sides of the base portion 2011. The base portion 2011 is substantially circular, and defines a mounting hole 2015 in a center position thereof. A flange 2017 is formed on an inside surface of the mounting hole 2015. A latching groove 2019 is defined in the inside surface of the mounting hole 2015, for receiving the latching ring 207. The bearing 203 defines a shaft hole 2031. An inner diameter of the shaft hole 2031 is substantially the same as an outer diameter of the bushing 205, such that the bearing 203 is sleeved on the bushing 205. The bushing 205 installed with the bearing 203 is mounted in the mounting hole 2015 of the bearing seat 201, and is supported by the flange 2017. The latching ring 207 is a C-shaped ring. The latching ring 207 is mounted in the latching groove 2019, for preventing the bushing 205 installed with the bearing 203 from sliding out.

The assembly apparatus 100 includes a base 10, a transferring mechanism 30, a first assembly mechanism 50, a second assembly mechanism 70, and a collecting assembly 80. The transferring mechanism 30, the first assembly mechanism 50, and the second assembly mechanism 70 are mounted on the base 10 next to each other. The transferring mechanism 30 is movably mounted on one end of the base 10, for transferring and positioning the bearing seat 201 to be assembled. The first assembly mechanism 50 is mounted in a middle portion of the base 10, for installing the bearing 203 and the bushing 205 on the bearing seat 201. The second assembly mechanism 70 is mounted on the other end of the base 10 away from the transferring mechanism 30, for installing the latching ring 207 into the latching groove 2019 of the bearing seat 201. The collecting assembly 80 is mounted on a side of the base 10 adjacent to the second assembly mechanism 70, for collecting the bearing assembly 200 assembled by the assembly apparatus 100.

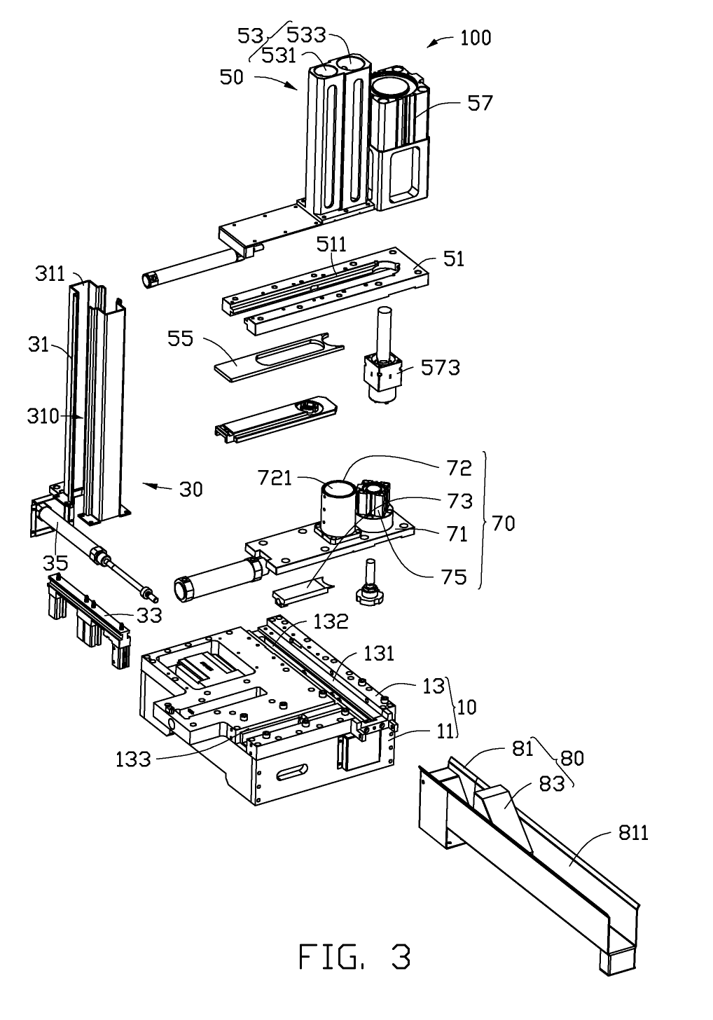

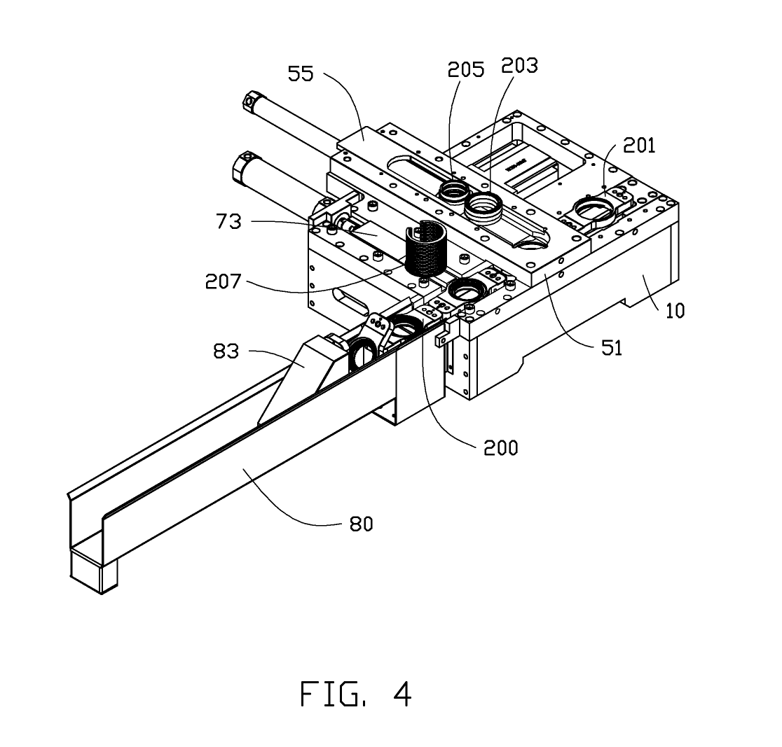

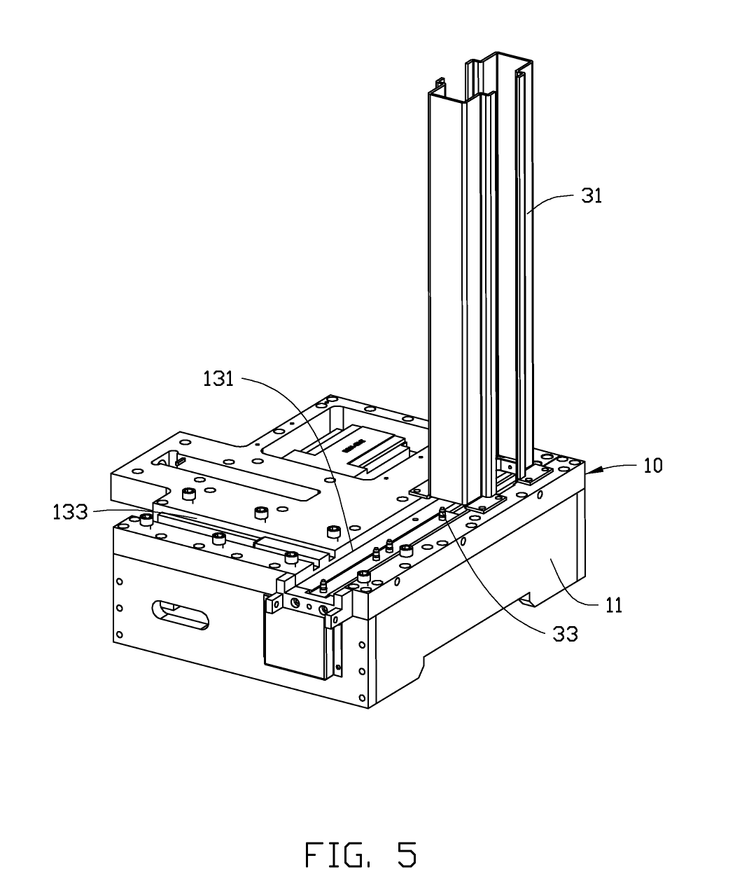

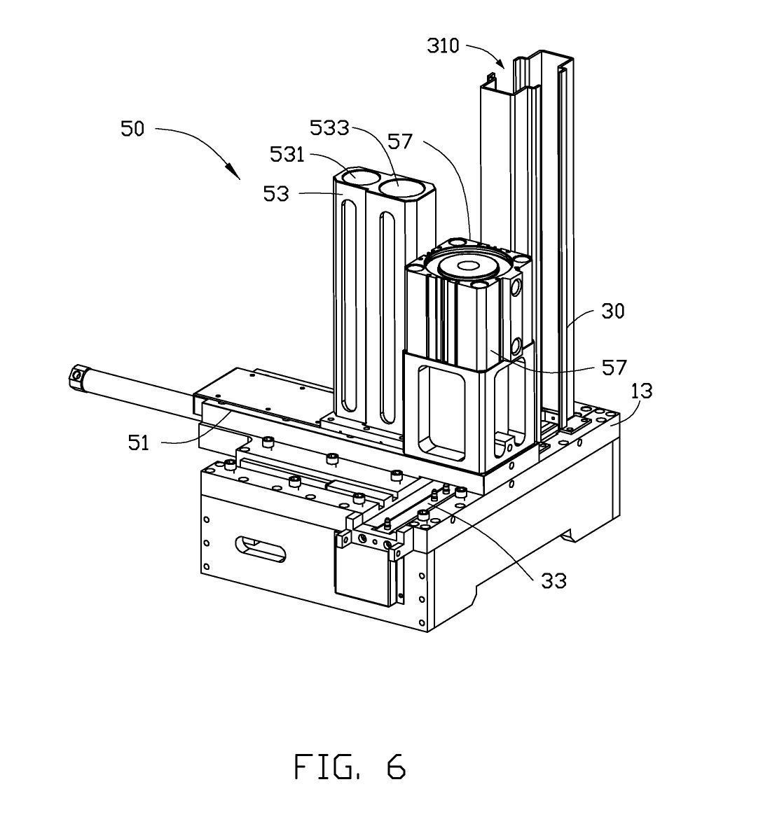

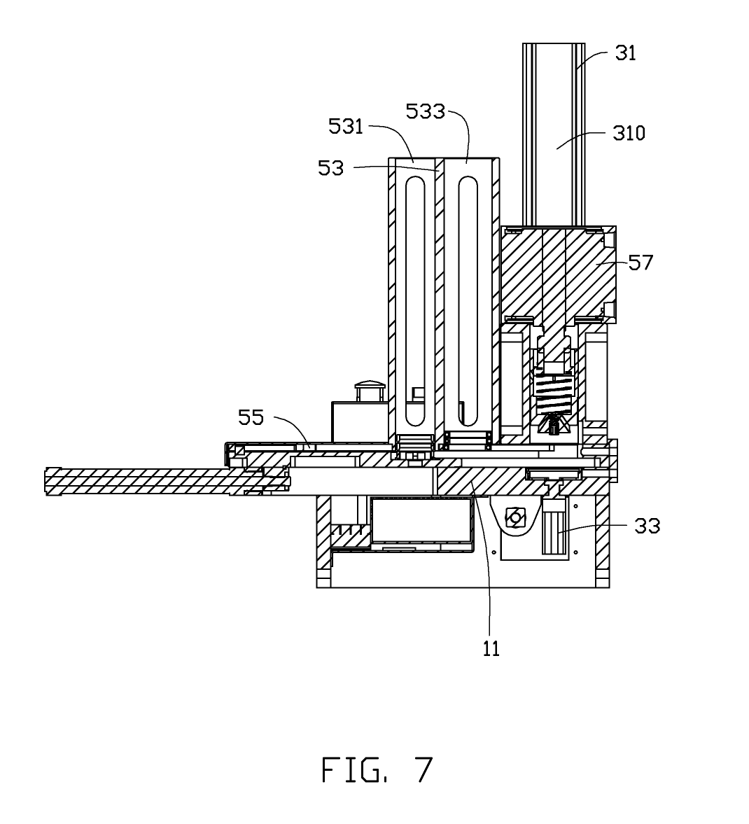

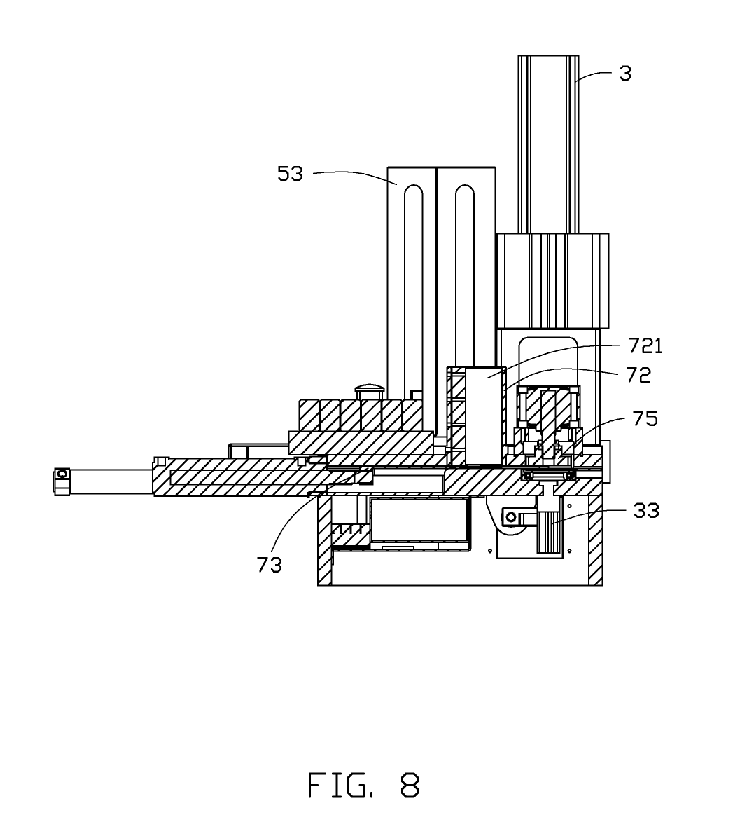

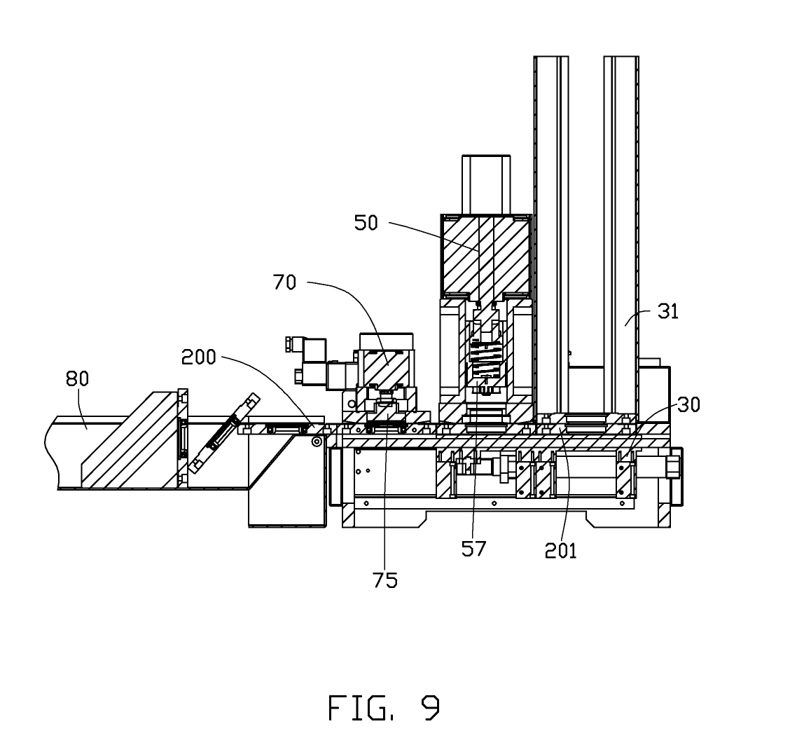

Referring also to FIGS. 3 through 9, the base 10 includes a support portion 11 and a mounting portion 13 fixed on the support portion 11. The support portion 11 is substantially frame-like, for supporting the mounting portion 13. The mounting portion 13 is substantially rectangular and plate-like. A sliding groove 131 is defined in the mounting portion 13, for transferring the bearing seat 201 to be assembled. In the illustrated embodiment, the sliding groove 131 extends from one end to the other end of the mounting portion 13. A communicating slot 132 is defined in a bottom wall of the sliding groove 131. A transferring groove 133 is defined in the mounting portion 13 adjacent to the transferring mechanism 30. An extension direction of the transferring groove 133 is substantially perpendicular to the extension direction of the sliding groove 131.

The transferring mechanism 30 includes two guiding members 31, a transferring assembly 33, and a driving member 35. The guiding members 31 are symmetrically mounted on two sides of the sliding groove 131. Each guiding member 31 defines a guiding groove 311 substantially perpendicularly to the sliding groove 131. The guiding members 31 cooperatively form a guiding cavity 310 therebetween communicating to the sliding groove 131. The bearing seat 201 is received in the guiding cavity 310, and slides along the guiding grooves 311 into the sliding groove 131.

The transferring assembly 33 is movably mounted in the communicating slot 132 below the sliding groove 131, for transferring the bearing seat 201 to the first assembly mechanism 50. The driving member 35 is mounted on the support portion 11 and connected to the transferring assembly 33, for driving the transferring assembly 33 to slide along the communicating slot 132.

The first assembly mechanism 50 includes a support plate 51, a guiding member 53, a pushing member 55, and a first installing assembly 57. The support plate 51 is securely placed on the mounting portion 13, and is substantially perpendicular to the sliding groove 131. The support plate 51 is substantially rectangular and plate-like. A transferring groove 511 is defined in one end of the support plate 51 extending away from the other end of the support plate 51. The transferring groove 511 communicates with the sliding groove 131.

The guiding member 53 is securely mounted on a middle portion of the support plate 51 above the transferring groove 511. A first receiving groove 531 and a second receiving groove 533 are defined in the guiding member 53 along a longitudinal direction thereof. The first receiving groove 531 and the second receiving groove 533 communicate with the transferring groove 511, for transferring the bushing 205 or the bearing 203 to the transferring groove 511.

The pushing member 55 is movably mounted on the sidewalls of the transferring groove 511 below the guiding member 53, for further transferring the bushing 205 and the bearing 203 to the first installing assembly 57.

The first installing assembly 57 is mounted on the support plate 51 adjacent to the guiding member 53. The first installing assembly 57 is positioned above the sliding groove 131, for installing the bearing 203 and the bushing 205 into the mounting hole 2015 of the bearing seat 201.

The second assembly mechanism 70 includes a mounting plate 71, a guiding member 72, a conveying member 73, and a second installing assembly 75. The mounting plate 71 is securely mounted on the mounting portion 13 above the transferring groove 133. Two mounting holes (not shown) are defined in the mounting plate 71 spaced from each other. The guiding member 72 is securely placed on the mounting plate 71 above one mounting hole thereof. The guiding member 72 is a substantially hollow cylinder defining a receiving hole 721. The receiving hole 721 communicates with the transferring groove 133, for transferring the latching ring 207 to the transferring groove 133.

The conveying member 73 is movably placed in the transferring groove 133 below the guiding member 72, for transferring the latching ring 207 to the second installing assembly 75. The second installing assembly 75 is placed on the mounting plate 71 adjacent to the guiding member 72 and is above the sliding groove 131, for installing the latching ring 207 into the latching groove 2019 of the bearing seat 201.

The collecting assembly 80 includes a collecting member 81 and a blocking piece 83. The collecting member 81 is mounted on a side of the base 10 adjacent to the second assembly mechanism 70, for collecting the bearing assembly 200 assembled by the assembly apparatus 100. A receiving groove 811 is defined in the collecting member 81 along a longitudinal direction thereof. The receiving groove 811 communicates with the sliding groove 131, for receiving the assembled bearing assembly 200. An extension direction of the receiving groove 811 is the same as the extension direction of the sliding groove 131. The blocking piece 83 is movably mounted in the receiving groove 811.

The assembly apparatus 100 further includes a controller (not shown). In the illustrated embodiment, the controller is a programmable logic controller, and is capable of controlling the assembly apparatus 100.

In assembly, firstly, the driving member 35 is mounted on the support portion 11, the transferring assembly 33 is movably mounted in the communicating slot 132 below the sliding groove 131, and connected to the driving member 35, and then the guiding members 31 are symmetrically mounted on two sides of the sliding groove 131, such that the transferring mechanism 30 is installed on the base 10. Secondly, the support plate 51 is securely placed on the mounting portion 13, the pushing member 55 is movably mounted in the sidewalls of the transferring groove 511, the guiding member 53 is securely mounted on the support plate 51 above the pushing member 55, and then the first installing assembly 57 is mounted on the support plate 51 adjacent to the guiding member 53, such that the first assembly mechanism 50 is installed on the base 10 adjacent to the transferring mechanism 30. Thirdly, the conveying member 73 is movably placed in the transferring groove 133, and then the mounting plate 71 is installed with the guiding member 72 and the second installing assembly 75 is securely mounted on the mounting portion 13 above the conveying member 73, such that the second assembly mechanism 70 is installed on the base 10. Lastly, the collecting assembly 80 is mounted on a side of the base 10 adjacent to the second assembly mechanism 70.

In use, firstly, the bearing seats 201 to be assembled are received in the guiding cavity 310, the bushing 205 to be assembled are received in the first receiving groove 531, and the bearings 203 are received in the second receiving groove 533, and the latching rings 207 to be assembled are received in the receiving hole 721. Secondly, the bearing seat 201 slides on the transferring assembly 33, then the bearing seat 201 is transferred to the first assembly mechanism 50 by the transferring assembly 33. Thirdly, the bushing 205 and the bearing 203 are pushed above the bearing seat 201 in the sliding groove 131, the bushing 205 is installed in the shaft hole 2031 of the bearing 203 by the first installing assembly 57, and then the bearing 203 installed along with the bushing 205 is installed in the mounting hole 2015 of the bearing seat 201 by the first installing assembly 57. Thirdly, the bearing seat 207 installed along with the bearing 203 and the bushing 205 is transferred below the second assembly mechanism 70, the latching ring 207 slides above the bearing seat 201 installed along with the bearing 203 and the bushing 205, and then the latching ring 207 is installed in the latching groove 2019 of the bearing seat 201 to complete the assembly of the bearing assembly 200. Lastly, the bearing assembly 200 slides to the receiving groove 811.

The assembly apparatus 100 is capable of automatically assembling the bearing assembly 200. Thus, the assembly process is simple and has a high efficiency. In addition, the bearing 203 does not contact the hands of the operators, such that a risk of rusting for the bearing 203 is relatively low.

In other embodiments, the collecting assembly 80 can be omitted, and the bearing assembly 200 assembled is collected manually.

While various embodiments have been described and illustrated, the disclosure is not to be construed as being restricted thereto. Various modifications can be made to the embodiments by those skilled in the art without departing from the true spirit and scope of the disclosure as defined by the appended claims.

What is claimed is:

1. An assembly apparatus for automatically assembling a bearing assembly, the bearing assembly comprising a bearing seat, a bearing defining a mounting hole, a bushing, and a latching ring, a latching groove being defined in an inside surface of the mounting hole, the assembly apparatus comprising:
a base;
a transferring mechanism movably mounted on the base, for transferring and positioning the bearing seat;
a first assembly mechanism mounted on the base adjacent to the transferring mechanism, for installing the bearing and the bushing into the mounting hole of the base; and
a second assembly mechanism mounted on the base adjacent to the first assembly mechanism, for installing the latching ring into the latching groove of the bearing seat.

2. The assembly apparatus of claim 1, wherein a sliding groove is defined in the base, a communicating slot is defined in a bottom wall of the sliding groove, and the transferring mechanism is movably mounted in the communicating slot.

3. The assembly apparatus of claim 2, wherein the transferring mechanism comprises a transferring assembly, and the transferring assembly is movably mounted in the communicating slot below the sliding groove.

4. The assembly apparatus of claim 2, wherein the first assembly mechanism comprises a support plate, a pushing member, and a first installing assembly; the support plate is securely placed on the base and substantially perpendicular to the sliding groove; the pushing member is movably mounted on the support plate for transferring the bushing and the bearing; and the first installing assembly is mounted on the support plate above the sliding groove, for installing the bearing and the bushing into the mounting hole of the bearing seat.

5. The assembly apparatus of claim 4, wherein a transferring groove is defined in the support plate, the transferring groove communicates with the sliding groove, and the pushing member is movably mounted on sidewalls of the transferring groove.

6. The assembly apparatus of claim 5, wherein the first assembly mechanism further comprises a guiding member, the guiding member is securely mounted on a middle portion of the support plate above the transferring groove, a first receiving groove and a second receiving groove are defined in the guiding member along a longitudinal direction of the guiding member, and the first receiving groove and the second receiving groove communicate with the transferring groove, for transferring the bushing or the bearing to the transferring groove.

7. The assembly apparatus of claim 2, wherein a transferring groove is defined in the base and communicating with the sliding groove, an extension direction of the transferring groove is substantially perpendicular to the extension direction of the sliding groove, and the second assembly mechanism is mounted on the base above the transferring groove.

8. The assembly apparatus of claim 7, wherein the second assembly mechanism comprises a conveying member and a second installing assembly, the conveying member is movably placed in the transferring groove for transferring the latching ring to the second installing assembly; and the second installing assembly is placed above the sliding groove, for installing the latching ring into the latching groove of the bearing seat.

9. The assembly apparatus of claim 3, wherein the transferring mechanism further comprises two guiding members, the two guiding members are symmetrically mounted on two sides of the sliding groove.

10. The assembly apparatus of claim 1, wherein the assembly apparatus further comprises a collecting assembly mounted on a side of the base adjacent to the second assembly mechanism.

11. An assembly apparatus for automatically assembling a bearing assembly, the bearing assembly comprising a bearing seat, a bearing defining a mounting hole, a bushing, and a latching ring, a latching groove being defined in an inside surface of the mounting hole, the assembly apparatus comprising:
a base defining a sliding groove, wherein a communicating slot is defined in a bottom wall of the sliding groove;
a transferring mechanism movably mounted in the communicating slot of the base, for transferring and positioning the bearing seat;
a first assembly mechanism mounted on the base adjacent to the transferring mechanism, for installing the bearing and the bushing into the mounting hole of the base;
a second assembly mechanism mounted on the base adjacent to the first assembly mechanism, for installing the latching ring into the latching groove of the bearing seat; and
a collecting assembly mounted on a side of the base adjacent to the second assembly mechanism.

12. The assembly apparatus of claim 11, wherein the collecting assembly comprises a collecting member, the collecting member defines a receiving groove communicating with the sliding groove.

13. The assembly apparatus of claim 11, wherein the transferring mechanism comprises a transferring assembly and two guiding members, the transferring assembly is movably mounted in the communicating slot below the sliding groove, and the two guiding members are symmetrically mounted on two sides of the sliding groove.

14. The assembly apparatus of claim 11, wherein the first assembly mechanism comprises a support plate, a pushing member, and a first installing assembly; the support plate is securely placed on the base and substantially perpendicular to the sliding groove; the pushing member is movably mounted on the support plate for transferring the bushing and the bearing; and the first installing assembly is mounted on the support plate above the sliding groove, for installing the bearing and the bushing into the mounting hole of the bearing seat.

15. The assembly apparatus of claim 14, wherein a transferring groove is defined in the support plate, the transferring groove communicates with the sliding groove, and the pushing member is movably mounted on sidewalls of the transferring groove.

16. The assembly apparatus of claim 15, wherein the first assembly mechanism further comprises a guiding member, the guiding member is securely mounted on a middle portion of the support plate above the transferring groove, a first receiving groove and a second receiving groove are defined in the guiding member along a longitudinal direction of the guiding member, and the first receiving groove and the second receiving groove communicate with the transferring groove, for transferring the bushing or the bearing to the transferring groove.

17. The assembly apparatus of claim 11, wherein a transferring groove is defined in the base communicating with the sliding groove, an extension direction of the transferring groove is substantially perpendicular to the extension direction of the sliding groove, and the second assembly mechanism is mounted on the base above the transferring groove.

18. The assembly apparatus of claim 17, wherein the second assembly mechanism comprises a conveying member and a second installing assembly, the conveying member is movably placed in the transferring groove for transferring the latching ring to the second installing assembly; and the second installing assembly is placed above the sliding groove, for installing the latching ring into the latching groove of the bearing seat.
